(19) United States
(12) Patent Application Publication
(10) Pub. No.: US 2024/0190404 A1
(43) Pub. Date: Jun. 13, 2024

(54) ELECTROHYDRAULIC DUAL-CIRCUIT POWER BRAKE SYSTEM

(71) Applicant: Robert Bosch GmbH, Stuttgart (DE)

(72) Inventors: Andreas Weh, Sulzberg (DE); Martin Hagspiel, Rettenberg (DE); Matthias Mayr, Rettenberg (DE)

(21) Appl. No.: 18/551,237

(22) PCT Filed: Sep. 21, 2022
(86) PCT No.: PCT/EP2022/076144

§ 371 Date: Sep. 19, 2023

(30) Foreign Application Priority Data
Oct. 21, 2021 (DE) 10 2021 211 891.7

(51) Int. Cl. B60T 8/176; B60T 7/12

(52) U.S. Cl. CPC B60T 8/176; B60T 7/12; B60T 2270/402; B60T 2270/413

(57) ABSTRACT

Hydraulically separating both brake circuits of an electrohydraulic dual-circuit power brake system. A piston-cylinder unit having two pistons is provided, the first piston of which being displaceable with a first electric motor via a worm gear and the second piston of which being displaced by subjecting it to pressure by the first piston.

### FIELD

The present invention relates to an electrohydraulic dual-circuit power brake system.

### BACKGROUND INFORMATION

Electrohydraulic power brake systems generate hydraulic brake pressure for actuating hydraulic wheel brakes with external power, for which purpose a piston is, for example, displaced with an electric motor via a screw drive in a cylinder. A manually actuatable master brake cylinder for alternative actuation of the power brake system can be present in particular for the purpose of auxiliary braking, for example in the event of failure of the electric motor or the power supply thereof.

Such power brake systems are described in European Patent Application Nos. EP 1 970 271 A1 and EP 2 641 788 A1 with the special feature that the cylinder for power braking is designed, like a master brake cylinder of a hydraulic dual-circuit vehicle brake system, as a dual-circuit cylinder for hydraulically separate connection of two brake circuits. Like a dual-circuit master brake cylinder, the cylinder for power braking in the two patent applications also has two pistons which are arranged coaxially one behind the other and at a distance from one another in the cylinder and of which a first piston, also referred to as primary piston or rod piston, is displaced with an electric motor via a ball screw drive in the cylinder, and a second piston, also referred to as secondary piston or floating piston, is subjected to the hydraulic brake pressure which the first piston generates, as a result of which the second piston generates the same brake pressure.

### SUMMARY

A electrohydraulic dual-circuit power brake system according to an example embodiment of the present invention has a piston-cylinder unit, in the cylinder of which two pistons are arranged as in a manually actuated dual-circuit master brake cylinder. In order to generate hydraulic brake pressure with external power, a first of the two pistons can be displaced with a first electric motor via a rotation/translation conversion gear, such as a screw drive, in the cylinder of the piston-cylinder unit. A second of the two pistons is subjected, on a rear side facing the first piston, to the brake pressure which the first piston generates, and is thereby likewise displaced in the cylinder of the piston-cylinder unit or likewise generates hydraulic brake pressure on a front side facing away from the first piston. The rear side of the second piston is an end face or piston surface of the second piston facing the first piston, and the front side is an end face or piston surface of the second piston facing away from the first piston. If the first piston does not generate any pressure in the cylinder of the piston-cylinder unit during its displacement, for example as a result of leakage, the first piston, during its displacement, strikes the second piston and displaces the second piston mechanically in the cylinder.

As in the case of a dual-circuit master brake cylinder, two brake circuits are connected to the cylinder of the piston-cylinder unit in a manner hydraulically separated from one another by the second piston.

In order to increase the availability of the power brake system according to the present invention, it has a power brake pressure generator with which hydraulic brake pressure can be generated independently of and as an alternative to the brake pressure generation with the piston-cylinder unit. As a result, the power brake system according to the present invention is suitable for autonomous driving. The power brake pressure generator can, for example, be a hydraulic pump of a slip control of the power brake system. Preferably, the power brake system has a hydraulic pump in each brake circuit.

According to an example embodiment of the present invention, the power brake pressure generator (s) is/are connected by a check valve to a brake fluid container, as a result of which they can draw brake fluid for generating the hydraulic brake pressure from the brake fluid container while bypassing the piston-cylinder unit. The power brake pressure generator can be connected to the brake fluid container by a common check valve. For the hydraulic separation of the brake circuits, a check valve is preferably present for each power brake pressure generator or in each brake circuit. Also possible are embodiments of the present invention in which only one power brake pressure generator is connected by the check valve to the brake fluid container. The check valve enables the generation of the hydraulic brake pressure with the power brake pressure generator even if, due to a fault, one or both pistons of the piston-cylinder unit are fixed in the cylinder in a non-displaceable manner in a forward-displaced position, in which they hydraulically separate the brake circuits from the brake fluid container.

The cylinder of the piston-cylinder unit is likewise connected to the brake fluid container or possibly also to a separate brake fluid container. It can be connected to the brake fluid container directly without an interposed check valve, by the check valve by which the power brake pressure generator is connected to the brake fluid container, or by a separate check valve. Different connection possibilities of the cylinder of the piston-cylinder unit to the brake fluid container are not excluded by the present invention.

Further developments and advantageous embodiments of the present invention are disclosed herein.

According to an example embodiment of the present invention, it is possible to design the power brake system without a manually actuatable master brake cylinder.

All of the features disclosed in the description herein and the figures can be implemented individually or, in principle, in any combination in embodiments of the present invention. Embodiments of the present invention that do not have all of the features, but rather only one or more features of an embodiment of the present invention are possible, in principle. For example, embodiments of the power brake system according to the present invention without a check valve between the brake fluid container and the power brake pressure generator are possible.

### BRIEF DESCRIPTION OF THE DRAWINGS

The present invention is explained in more detail below with reference to an example embodiment shown in the figures.

FIGS. 1 and 2 show hydraulic circuit diagrams of two example embodiments of electrohydraulic power brake systems according to the present invention.

### DETAILED DESCRIPTION OF EXAMPLE EMBODIMENTS

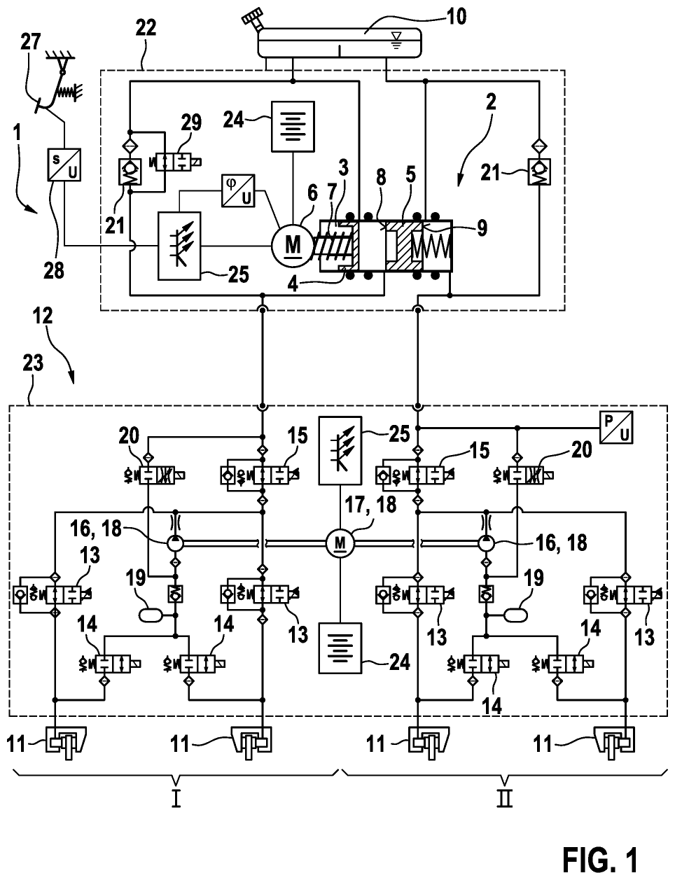

The electrohydraulic dual-circuit power brake system 1 shown in FIG. 1 has a piston-cylinder unit 2 with a cylinder 3, in which two pistons 4, 5 are arranged displaceably as in a conventional, manually actuatable dual-circuit master brake cylinder. In order to generate hydraulic brake pressure with external power, a first of the two pistons 4 can be displaced with a first electric motor 6 via a worm gear 7 in the cylinder 3. In the exemplary embodiment, the worm gear 7 is a ball screw drive. The worm gear 7 can generally be regarded as a rotation/translation conversion gear. A reduction gear (not shown), in particular a planetary gear, can be arranged between the first electric motor 6 and the worm gear 7. According to the present invention, the first electric motor 6, the worm gear 7 and, if present, the reduction gear are arranged coaxially with the piston-cylinder unit 2, i.e., coaxially with the cylinder 3 and with the two pistons 4, 5, wherein the present invention does not, in principle, exclude other arrangements of the first electric motor 6, of the worm gear 7 and, where applicable, of the reduction gear with respect to the piston-cylinder unit 2, the cylinder 3 and the pistons 4, 5.

The hydraulic brake pressure generated with the first piston 4 in the cylinder 3 acts on an end face or piston surface of the second piston 5 that faces the first piston 4 and is referred to herein as the rear side 8 of the second piston 5, as a result of which the second piston 5 is displaced in the cylinder 3 and generates hydraulic brake pressure on its face or piston surface that faces away from the first piston 4 and is referred to herein as the front side 9 of the second piston 5.

If the first piston 4 does not generate any pressure in the cylinder 3 during its displacement, for example as a result of leakage, said first piston, during its displacement, strikes the second piston 5 and displaces it mechanically by its abutment thereon so that the second piston 5 in this case also generates hydraulic brake pressure on its front side 9 in the cylinder 3.

Arranged on the cylinder 3 of the piston-cylinder unit 2 is a pressureless brake fluid container 10, to which the cylinder 3 is connected between the two pistons 4, 5 and on the front side 9 of the second piston 5.

The power brake system 1 according to the present invention is designed as a dual-circuit brake system with two brake circuits I, II and, in the exemplary embodiment, four hydraulic wheel brakes 11, of which two are in each case connected to a brake circuit I, II. A first of the two brake circuits I is connected between the two pistons 4, 5 to the cylinder 3 of the piston-cylinder unit 2 in such a way that the first brake circuit I is subjected to the hydraulic brake pressure which the first piston 4 generates in the cylinder 3 during its displacement.

The second brake circuit II is connected to the cylinder 3 of the piston-cylinder unit 3 on the front side 9 of the second piston 6 and is subjected to the brake pressure which the second piston 5 generates or which prevails in the cylinder 3 on the front side 9 of the second piston 5.

The second piston 5, on the rear side 8 of which the first brake circuit I and on the front side 9 of which the second brake circuit II is connected to the cylinder 3 of the piston-cylinder unit 2, separates the two brake circuits I, II from one another hydraulically.

The power brake system 1 has a slip control 12 with an inlet valve 13 and an outlet valve 14 for each wheel brake 11. The wheel brakes 12 are connected to the cylinder 3 of the piston-cylinder unit 2 by the inlet valves 13, wherein an isolating valve 15 is arranged between the cylinder 3 and the inlet valves 13 in each brake circuit I, II. In this case, the first brake circuit I is connected to the cylinder 3 by its isolating valve 15 between the two pistons 4, 5 and the second brake circuit II is connected to said cylinder by its isolating valve 15 on the front side 9 of the second piston 5.

The wheel brakes 11 in each brake circuit I, II are connected by the outlet valves 14 to a suction side of a hydraulic pump 16, wherein the two hydraulic pumps 16 of the two brake circuits I, II can be driven with a common second electric motor 17. The hydraulic pumps 16 with the second electric motor 17 are part of the slip control 12 and form power brake pressure generators 18. Pressure sides of the hydraulic pumps 16 are connected between the isolating valves 15 and the inlet valves 13. A hydraulic accumulator 19 for temporarily storing brake fluid from the wheel brakes 11 during a slip control is provided on each of the suction sides of the hydraulic pumps 16. Furthermore, the suction sides of the hydraulic pumps 16 are connected by intake valves 20 to the cylinder 3 of the piston-cylinder unit 2. In fact, as in the case of the isolating valves 15, the brake circuit I is connected to the cylinder 3 by its intake valve 20 between the two pistons 4, 5 and the brake circuit II is connected to said cylinder by its intake valve 20 on the front side 9 of the second piston 5.

The inlet valves 13, outlet valves 14, isolating valves 15 and intake valves 19, which are components of the slip control 12, and the connection valve 29 in the exemplary embodiment are 2/2-way solenoid valves, wherein the inlet valves 13, the isolating valves 15 and the connection valve 29 are open in their currentless basic positions and the outlet valves 14 and the intake valves 19 are closed in their currentless basic positions. A wheel-specific brake pressure control in the wheel brakes 11 is possible with the slip control 12. In particular, slip controls such as anti-lock control, traction slip control and driving dynamics control are possible, for which the abbreviations ABS, ASR and FDR are common. Such slip controls are conventional and are not explained in more detail here.

A redundancy is ensured by the hydraulic pumps 16 of the slip control 12 which can be driven with the second electric motor 17 and form the power brake pressure generator 18, i.e., as an alternative to generating hydraulic brake pressure by displacing the pistons 4, 5 in the cylinder 3 of the piston-cylinder unit 2, 5, hydraulic brake pressure can be generated by driving the hydraulic pumps 16 of the slip control 12, as a result of which availability of the power brake system 1 according to the present invention is ensured even in the event of a failure of the first electric motor 6, as a result of which the power brake system 1 is also suitable for autonomous driving.

As in a master brake cylinder, the cylinder 3 of the piston-cylinder unit 2 is connected to the brake fluid container 10 in such a way that the pistons 4, 5 hydraulically separate the cylinder 3 from the brake fluid container 10 when they are being displaced from a basic position to generate the brake pressure.

The two brake circuits I, II are connected to the brake fluid container 10 by check valves 21, which are arranged between the brake fluid container 10 on the one hand and the isolating valves 15 and the intake valves 20 on the other hand and can be flowed through in the direction from the brake fluid container 10 to the brake circuits I, II, i.e., to the isolating valves 15 and the intake valves 20. By means of the check valves 21, the hydraulic pumps 16 of the slip control 12 can draw brake fluid out of the brake fluid container 10 past the cylinder 3 of the piston-cylinder unit 2 when the intake valves 19 are opened. This enables the generation of the brake pressure with external power, inter alia even if, for example, the pistons 4, 5 in the cylinder 3 of the piston-cylinder unit 2 are stuck in the cylinder 3 or blocked in another way in a forward-displaced position in which they hydraulically separate the brake fluid container 10 from the cylinder 3.

The check valves 21 also connect the cylinder 3 of the piston-cylinder unit 2 to the brake fluid container 10, as a result of which the pistons 4, 5 can draw brake fluid out of the brake fluid container 10 into the cylinder 3 during a return stroke. Embodiments of the power brake system 1 without the check valves 21 or with a check valve 21 only in one of the two brake circuits I, II (not shown) are not excluded by the present invention.

Arranged hydraulically parallel to the check valve 21 is a connection valve 29, through which, when it is open, brake fluid is pushed out of the piston-cylinder unit 2 by means of the first piston 4 and brake fluid from the brake circuit I can be conveyed with the hydraulic pump 18 out of the pressure control module 23 into the brake fluid container 10. The connection valve 29 is not mandatory for the present invention.

Also possible is an embodiment of the power brake system 1 without the check valve 21 in the brake circuit II, which is subjected to brake pressure by the second piston 5. In this case, the brake circuit II is connected directly to the brake fluid container 10 (not shown).

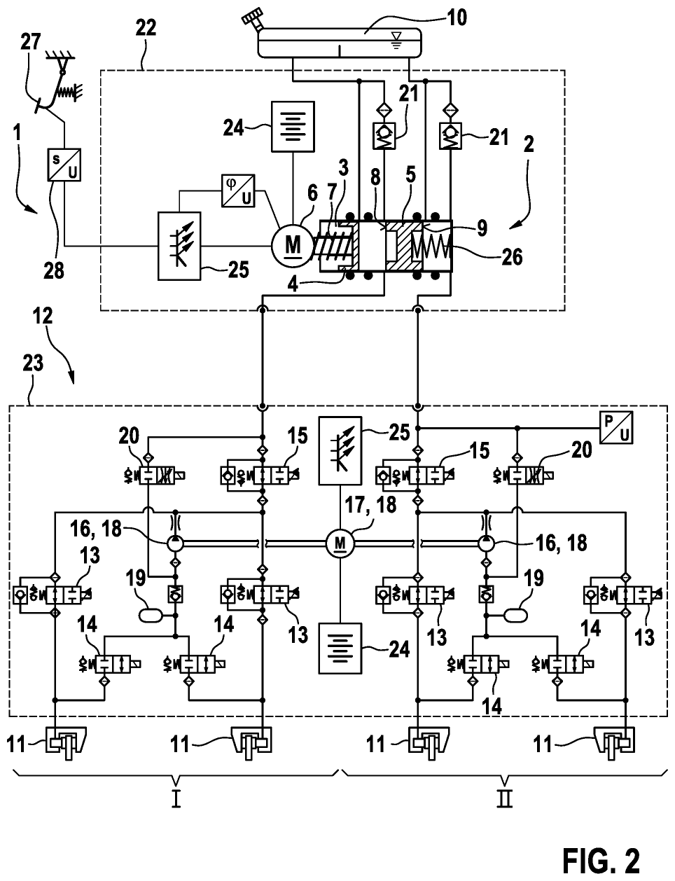

In FIG. 2, the check valves 21 connect the brake fluid container 10 to the cylinder 3 of the piston-cylinder unit 2 in such a way that the cylinder 3 always communicates with the brake fluid container 10 by the check valves 21. That is to say that during their displacement in the cylinder 3, the pistons 4, 5 do not separate the connection of the cylinder 3 to the brake fluid container 10 by the check valves 21 differently than the direct connections of the cylinder 3 to the brake fluid container 10, which the two pistons 4, 5 close during their displacement in the cylinder 3 when they are being or are displaced out of their basic positions. In this embodiment of the present invention too, the hydraulic pumps 16 of the slip control 12, which form the power brake pressure generator 18, can draw brake fluid out of the brake fluid container 10 through the check valves 21 and the cylinder 3 of the piston-cylinder unit 2 when the pistons 4, 5 are displaced in the cylinder 3, as a result of which the generation of hydraulic brake pressure with the hydraulic pumps 16 is also possible in this embodiment of the present invention when the pistons 4, 5 displaced in the cylinder 3 are non-displaceably fixed in the cylinder 3. With the exception of the described arrangement of the check valves 21, the power brake system 1 according to the present invention is identical in the two figures, and the explanations of FIG. 1 are referenced for the explanation of FIG. 2.

In the exemplary embodiment of the present invention, the power brake system 1 is of a modular design, the piston-cylinder unit 2 is accommodated in a module, which is referred to here as a pressure generation module 22, and the slip control 12 is accommodated in another module, which is referred to here as a pressure control module 23. For a non-modular design of the power brake system 1, the piston-cylinder unit 2 and the slip control 12 can be accommodated in a common module (not shown).

For reasons of redundancy, the pressure generation module 22 and the pressure control module 23 each have a separate electrical power supply 24 and a separate electronic control unit 25, as a result of which the availability of the power brake system 1 is ensured in the event of an error in the pressure generation module 22 or in the pressure control module 24 or the slip control 12.

A piston return spring 26 is arranged on the front side 9 of the second piston 5 in the cylinder 3 of the piston-cylinder unit 2 and loads the second piston 5 into its basic position. The first piston 4 does not have a piston return spring, wherein the present invention does not exclude such a spring. In the exemplary embodiment, the first piston 4 is connected in a tension-resistant manner to the worm gear 7, which can generally also be regarded as a rotation/translation conversion gear, in such a way that the first piston 4 can be displaced with the first electric motor 6 via the worm gear 7 in the cylinder 3 not only for generating the brake pressure but also in an opposite direction.

The power brake system 1 has a spring-loaded foot brake pedal 27 with a path sensor 28 or optionally a force sensor as the setpoint generator for the brake pressure to be generated with the piston-cylinder unit 2. For redundancy, a plurality of path sensors or force sensors or one path sensor and one force sensor can also be provided (not shown). In principle, it is possible to provide a manually actuatable single-circuit master brake cylinder with which one of the two brake circuits I, II can be subjected to hydraulic brake pressure as an alternative to the pressure generation with the piston-cylinder unit 2, or a dual-circuit master brake cylinder with which both brake circuits I, II can be subjected to pressure (not shown). With such a master brake cylinder, the power brake system 1 can be actuated manually, in particular in the event of failure of the first piston-cylinder unit 2 and of the hydraulic pumps 16 of the slip control 12. In the exemplary embodiment shown, the power brake system 1 does not have a master brake cylinder and cannot be actuated manually. Due to the possibility of generating the brake pressure optionally with the piston-cylinder unit 2 or the hydraulic pumps 16, the power brake system 1 can nevertheless also be used for autonomous driving, in which the power brake system 1 must be able to be actuated autonomously even without actuation by a vehicle driver.

In order to return the pistons 4, 5 in the cylinder 3 of the piston-cylinder unit 2 in the event of a fault, according to the present invention, brake fluid can be conveyed with the hydraulic pumps 16 of the power brake pressure generator 18 out of the hydraulic accumulators 19 through the open isolating valves 15 into the cylinder 3 of the piston-cylinder unit 2 and brake pressure can be generated there, which acts on the pistons 4, 5 in the direction of the first electric motor 6. If the hydraulic accumulators 19 do not contain enough brake fluid, brake fluid can be conveyed beforehand with the hydraulic pumps 16 out of the brake fluid container 10 with closed isolating valves 15 through the intake valves 20 to be opened into the wheel brakes 11, from where the brake fluid flows into the hydraulic accumulators 19 after the inlet valves 13 and the intake valves 20 are closed and the outlet valves 14 are opened. The processes, i.e., alternately drawing the brake fluid with the hydraulic pumps 16 out of the brake fluid container 10 and conveying the brake fluid out of the hydraulic accumulators 18 into the cylinder 3 of the piston-cylinder unit 2, can be repeated several times in order to convey sufficient brake fluid into the cylinder 3 and to there generate a pressure sufficient to return the pistons 4, 5. The method can be carried out in both brake circuits I, II at the same time or in each brake circuit I, II by itself. Preferably, when the first piston 4 is returned, the isolating valve 15 of the other brake circuit II is closed so that, by subjecting it to pressure, the second piston 5 cannot push any brake fluid out of the cylinder 3 and does not yield or yields little to the pressure on its side facing the first piston 4.

1-9. (canceled)

10. An electrohydraulic dual-circuit power brake system, comprising:
a brake fluid container;
a piston-cylinder unit, a cylinder of piston-cylinder unit being connected to the brake fluid container, the piston-cylinder unit including a first piston which can be displaced with a first electric motor via a rotation/translation conversion gear in the cylinder of the piston-cylinder unit to generate hydraulic brake pressure, and a second piston which is displaced in the cylinder by subjecting it to hydraulic pressure by the first piston or mechanically by abutment of the first and second pistons on one another;
two brake circuits, which are connected to the cylinder of the piston-cylinder unit in a manner hydraulically separated from one another by the second piston; and
a power brake pressure generator using which hydraulic brake pressure in a brake circuit of the power brake system can be generated as an alternative to generating brake pressure with the piston-cylinder unit; and
a check valve through which the power brake pressure generator is connected to the brake fluid container.

11. The electrohydraulic dual-circuit power brake system according to claim 10, wherein the the power brake system includes a respective power brake pressure generator in each of the brake circuits, the respective power brake pressure generators being connected to the brake fluid container by a respective check valve in each of the brake circuits.

12. The electrohydraulic dual-circuit power brake system according to claim 10, wherein the first piston is connected to the rotation/translation conversion gear in a tension-resistant and pressure-resistant manner in such a way that the first piston can be displaced with the first electric motor via the rotation/translation conversion gear in two opposite directions in the cylinder of the piston-cylinder unit.

13. The electrohydraulic dual-circuit power brake system according to claim 10, wherein the first piston has no piston return spring.

14. The electrohydraulic dual-circuit power brake system according to claim 11, further comprising a slip control, which has the respective power brake pressure generators.

15. The electrohydraulic dual-circuit power brake system according to claim 10, wherein the first electric motor and the rotation/translation conversion gear are arranged coaxially with the cylinder of the piston-cylinder unit.

16. The electrohydraulic dual-circuit power brake system according to claim 14, wherein the power brake system has a redundant power supply and/or a redundant electronic control for the first electric motor of the piston-cylinder unit and for the respective power brake pressure generators or the slip control.

17. The electrohydraulic dual-circuit power brake system according to claim 10, wherein the power brake system does not have manual actuation.

18. A method for returning pistons of an electrohydraulic dual-circuit power brake system, the power brake system including:
a brake fluid container,
a piston-cylinder unit, a cylinder of piston-cylinder unit being connected to the brake fluid container, the piston-cylinder unit including a first piston which can be displaced with a first electric motor via a rotation/translation conversion gear in the cylinder of the piston-cylinder unit to generate hydraulic brake pressure, and a second piston which is displaced in the cylinder by subjecting it to hydraulic pressure by the first piston or mechanically by abutment of the first and second pistons on one another,
two brake circuits, which are connected to the cylinder of the piston-cylinder unit in a manner hydraulically separated from one another by the second piston; and
a power brake pressure generator using which hydraulic brake pressure in a brake circuit of the power brake system can be generated as an alternative to generating brake pressure with the piston-cylinder unit, and
a check valve through which the power brake pressure generator is connected to the brake fluid container,
wherein the power brake pressure generator is connected to the cylinder by a valve, and the method comprises:
subjecting at least one of the first and second pistons to hydraulic pressure, by the power brake pressure generator.
